(19) United States
(12) Patent Application Publication
(10) Pub. No.: US 2026/0204678 A1
(43) Pub. Date: Jul. 16, 2026

(54) METHOD FOR OPTIMIZED COOLING OF AN ELECTRIC OR HYBRID VEHICLE BATTERY

(71) Applicant: VALEO SYSTEMES THERMIQUES, La Verriere (FR)

(72) Inventors: Bertrand GESSIER, La Verriere (FR); Richard COTTET, La Verriere (FR); Francois CHARBONNELLE, La Verriere (FR)

(73) Assignee: VALEO SYSTEMES THERMIQUES, La Verriere (FR)

(21) Appl. No.: 18/714,132

(22) PCT Filed: Nov. 17, 2022
(86) PCT No.: PCT/EP2022/082314

§ 371 Date: May 29, 2024

(30) Foreign Application Priority Data
Nov. 29, 2021 (FR) FR2112661

(51) Int. Cl. H01M 10/651; B60H 1/00; B60L 53/14; B60L 58/12; B60L 58/26; H01M 10/613; H01M 10/625; H01M 10/633

(52) U.S. Cl. CPC H01M 10/651; B60H 1/00278; B60L 53/14; B60L 58/12; B60L 58/26; H01M 10/613; H01M 10/625; H01M 10/633; B60L 2240/545; B60L 2240/662

(57) ABSTRACT

A method for cooling a battery of an electric or hybrid vehicle, including: determining a curve showing the theoretical thermal power dissipated by the battery as a function of time during continuous charging of the battery at maximum charging power, and of the battery charging duration, determining a maximum thermal power dissipated by the battery during charging, determining a maximum cooling power of a device for cooling the battery, determining a theoretical maximum temperature reached by the battery during charging at maximum charging power, comparing the maximum cooling power with the maximum thermal power dissipated by the battery, and then starting the charging of the battery and, as a function of comparison, imposing a cooling power on the cooling device at one or more successive levels decreasing over time.

### TECHNICAL FIELD

The invention relates to electric or hybrid motor vehicles. More specifically, the invention relates to a method for cooling a battery of an electric or hybrid vehicle.

### BACKGROUND OF THE INVENTION

An electric or hybrid motor vehicle comprises a battery the use of which makes it possible to supply the vehicle with electric power. Prior to such use, the battery must be charged by supplying it with an electric current.

In order to reduce the duration of such charging as much as possible, as the vehicle cannot be used for driving during this time, so-called fast charging methods are known in the prior art, which implement a high-amperage direct electric current. As the electric power supplied to the battery is an increasing function of the current, it will be understood that an increase in the current allows an increase in the charging power. However, the thermal power dissipated by the battery by Joule heating is also an increasing function of the current, and even changes with the square of the current. This thermal power dissipated by the battery results in an increase in the temperature thereof. A battery has a temperature range for optimum operation, which means that it is necessary to ensure that its temperature remains within said range. The battery temperature must thus at all times remain above a minimum optimum operating temperature and below a limit, or maximum, optimum operating temperature, these two temperature values being predetermined for a given battery.

In this regard, it is known practice to use a cooling device of the vehicle, such as an air conditioning system, to cool the battery during fast charging. However, the cooling requirements of the battery depend on several parameters, in particular the state of charge (SOC) of the battery, and the outside temperature. It is thus necessary to adjust the cooling provided by the air conditioning system on each charge, or even to slow down charging if necessary.

To this end, it is known practice to control the charging and cooling in real time in order to keep the temperature of the battery in the range throughout charging. However, this can cause inconvenience for the user of the vehicle. Such control can give rise to the slowing of charging and to accelerations/decelerations of the cooling device that are difficult for the user to interpret, all the more so in that two successive charges of the battery system will not necessarily follow the same charging and cooling cycles. The user of the vehicle can erroneously interpret this as a malfunction of the vehicle, which it is preferable to avoid.

### SUMMARY OF THE INVENTION

A particular aim of the invention is to overcome these drawbacks by allowing the most optimized possible cooling of the battery during charging, without having multiple different cooling and charging phases that might cause confusion for the user of the vehicle.

To this end, a method is provided according to the invention for cooling a battery of an electric or hybrid vehicle, wherein:
a curve is determined showing the theoretical thermal power dissipated by the battery as a function of time during continuous charging of the battery at maximum charging power, and of the battery charging duration,
the maximum thermal power dissipated by the battery during charging is determined,
a maximum cooling power of a device for cooling the battery is determined,
a theoretical maximum temperature reached by the battery during charging at maximum charging power is determined, in particular taking into account the curve showing the theoretical thermal power dissipated by the battery, the outside temperature, and the initial state of charge of the battery,
the maximum cooling power is compared with the maximum thermal power dissipated by the battery, and then
the charging of the battery is started and, as a function of the comparison, a cooling power is imposed on the cooling device at one or more successive levels decreasing over time.

It is thus possible to optimize the charging and cooling of the battery by determining and comparing the quantities listed above. The general idea is to allow the most powerful charging and cooling at least at the start of charging, and if the maximum charging power is greater than the maximum cooling power, these powers are then adjusted in at least a second phase in order to obtain a suitable balance between charging and cooling. It will therefore be understood that the charging time can be optimized as a function of the battery parameters, in particular its state of charge, and external parameters, such as the ambient temperature and the maximum power of the cooling device.

Further, due to the implementation of successive levels of rotation speed of the compressor of the cooling device that decrease over time, the operation satisfies the general intuition of the user of the vehicle. Such a user knows that a battery dissipates less heat as it charges, hence the reduction in the requirement for cooling by the cooling device as the battery charges. The decreasing successive levels of rotation speed of the compressor are not therefore a source of confusion for the user.

Advantageously, if the maximum thermal power dissipated by the battery is greater than the maximum cooling power, the theoretical maximum temperature of the battery is also compared with a maximum operating temperature of the battery.

It is thus also possible to adjust the method for cooling the battery in order to ensure that its temperature does not exceed a predetermined temperature. This is preferable, as exceeding a predetermined temperature could damage the battery.

According to a first embodiment of the invention wherein the theoretical maximum temperature of the battery is above the maximum operating temperature of the battery, the method successively comprises:
a first high cooling phase, during which the charging power is at maximum charging power and during which a first level is imposed on the cooling power that is equal to the maximum cooling power of the cooling device, throughout the high cooling phase,
a charging regulation phase, following the high cooling phase, during which a first level is still imposed on the cooling power that is equal to the maximum cooling power of the cooling device, together with a charging power of the battery according to a setpoint below the maximum charging power so that the thermal power dissipated by the battery is equal to the maximum cooling power imposed on the cooling device, and
a low cooling phase, following the charging regulation phase, during which the charging power is at maximum charging power and during which a cooling power is imposed on the cooling device at one or more levels, until the end of charging of the battery so that, during the low cooling phase, the mean cooling power is equal to the mean thermal power dissipated by the battery, the low cooling phase ending at the end of charging of the battery.

This embodiment corresponds to the situation in which the cooling device does not allow sufficient cooling of the battery to keep its temperature below the maximum operating temperature of the battery in the event of unrestricted charging of the battery throughout charging. In this case, the charging power is restricted temporarily to allow the cooling to catch up with the thermal power dissipated by the battery.

Preferably, the high cooling phase ends when the actual temperature of the battery reaches the maximum operating temperature.

The period of maximum charging power is thus maximized, which makes it possible to minimize the battery charging duration.

Preferably, the charging regulation phase ends when the actual thermal power dissipated by the battery returns to the theoretical thermal power dissipated by the battery.

This makes it possible to minimize the duration of the regulation phase during which the charging power is restricted and thus contributes to reducing the battery charging duration.

According to a second embodiment of the invention wherein the theoretical maximum temperature of the battery is below the maximum operating temperature of the battery, the method successively comprises:
a high cooling phase, during which the charging power is at maximum charging power and during which a cooling power is imposed on the cooling device at a level below the maximum cooling power of the cooling device, throughout the high cooling phase,
a low cooling phase, following the high cooling phase, during which the charging power is at maximum charging power and during which a cooling power is imposed at one or more levels that decrease over time and are below the intermediate rotation speed level so that, during the low cooling phase, the mean cooling power is equal to the mean thermal power dissipated by the battery, the low cooling phase ending at the end of charging of the battery.

This embodiment corresponds to the situation in which the cooling device allows sufficient cooling of the battery to keep its temperature below the maximum operating temperature of the battery in the event of unrestricted charging of the battery throughout charging. In this case, it is possible to allow maximum charging power throughout charging while imposing decreasing successive levels of rotation speed of the compressor of the cooling device selected to limit the cooling power. This makes it possible to limit the energy consumption of the cooling device while keeping the battery temperature below its maximum operating temperature.

Preferably, the high cooling phase ends when the thermal power dissipated by the battery reaches the level of the cooling power of the cooling device.

The period of maximum charging power is thus maximized, which makes it possible to minimize the duration of the battery charging method.

According to a third embodiment of the invention wherein the maximum cooling power is greater than the maximum thermal power dissipated by the battery during charging at maximum charging power, the method comprises a single high charging phase, ending at the same time as the charging of the battery, during which the charging power is at maximum charging power and during which a cooling power is imposed on the cooling device at one or more levels below the maximum cooling power of the cooling device, throughout the charging of the battery, so that the actual temperature of the battery remains between the maximum operating temperature of the battery and an optimum operating temperature threshold of the battery.

This embodiment corresponds to the situation in which the cooling device allows sufficient cooling to prevent any temperature increase of the battery during charging. In this case, the cooling power is nevertheless limited in order to limit the energy consumption of the cooling device.

Preferably, the high cooling phase starts if the initial temperature of the battery is greater than or equal to the optimum operating temperature threshold of the battery.

If it is necessary to increase the temperature of the battery, for example to improve its operating conditions if its initial temperature is too low, a charging phase without battery cooling is thus provided.

Advantageously, the device for cooling the battery is included in an air conditioning device for a vehicle passenger compartment, the determining of the maximum cooling power of the device for cooling the battery corresponding to the maximum cooling power of the air conditioning device minus the cooling power used for cooling the passenger compartment.

The invention can thus be adapted to a situation in which the cooling device is not entirely dedicated to battery cooling, which improves the flexibility of the invention.

### BRIEF DESCRIPTION OF THE DRAWINGS

The invention will be better understood upon reading the following description, which is given solely by way of example and with reference to the appended drawings, in which:

FIG. 1 is a schematic view of a motor vehicle comprising a battery and a cooling device,

FIG. 2 is a graph showing the change in the thermal power dissipated by the battery, the cooling power supplied by the cooling device, and the temperature of the battery as a function of time according to a first embodiment of a cooling method according to the invention,

FIG. 3 is a graph showing the change in the thermal power dissipated by the battery, the cooling power supplied by the cooling device, and the temperature of the battery as a function of time according to a second embodiment of the cooling method according to the invention,

FIG. 4 is a graph showing the change in the thermal power dissipated by the battery, the cooling power supplied by the cooling device, and the temperature of the battery as a function of time according to a third embodiment of the cooling method according to the invention, and

FIG. 5 is a flowchart showing method according to the invention.

### DETAILED DESCRIPTION OF THE INVENTION

Identical elements in the figures bear the same reference signs.

The following embodiments are examples. Although the description refers to one or more embodiments, this does not necessarily mean that each reference sign relates to the same embodiment, or that the features only apply to a single embodiment. Individual features of different embodiments can also be combined or interchanged to provide other embodiments.

In the present description, certain elements or parameters can be given ordinal numbers such as, for example, first element or second element, as well as first parameter and second parameter or even first criterion and second criterion, etc. In this case, this ordinal numbering is simply to differentiate between and denote elements or parameters or criteria that are similar but not identical. This ordinal numbering does not imply that one element, parameter or criterion takes priority over another and such designations can easily be interchanged without departing from the scope of the present description. Likewise, this ordinal numbering does not imply any chronological order, for example, in assessing any given criteria.

FIG. 1 shows an electric or hybrid motor vehicle 2. It comprises a battery 4 configured to supply energy to the vehicle in order to make it run, in a manner known per se. The vehicle 2 also comprises a cooling device 6 configured in particular to cool the battery 4 during the charging thereof. The battery 4 is charged by passing a current through the battery, which generates heat due to Joule heating. To this end, the cooling device 6 conventionally comprises a compressor, an evaporator arranged to cool the battery 4 and a condenser arranged to dissipate the heat coming from the battery 4. The cooling device 6 further comprises a fan arranged to that it generates an air stream through the condenser, the rotation speed of said fan following the same levels as the compressor. As such a cooling device configuration is known, it will not be described further below.

The vehicle 2 comprises an electronic control unit 8 making it possible to implement a cooling method, according to the invention, for cooling the battery 4 during the charging thereof. Such a method will now be described.

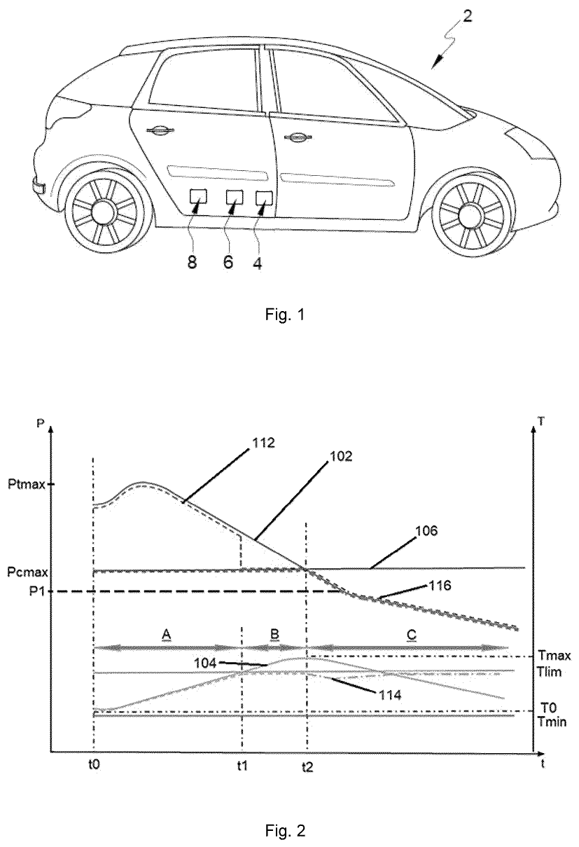

FIG. 2 is a graph showing the change in the thermal power dissipated by the battery 4, the cooling power P supplied by the cooling device 6, and the temperature T of the battery 4 as a function of time t according to a first embodiment of the cooling method. Such powers are generally expressed in Watts.

To start with, a number of theoretical quantities are measured, which make it possible to calibrate the method as closely as possible to the actual state of the battery and the external conditions.

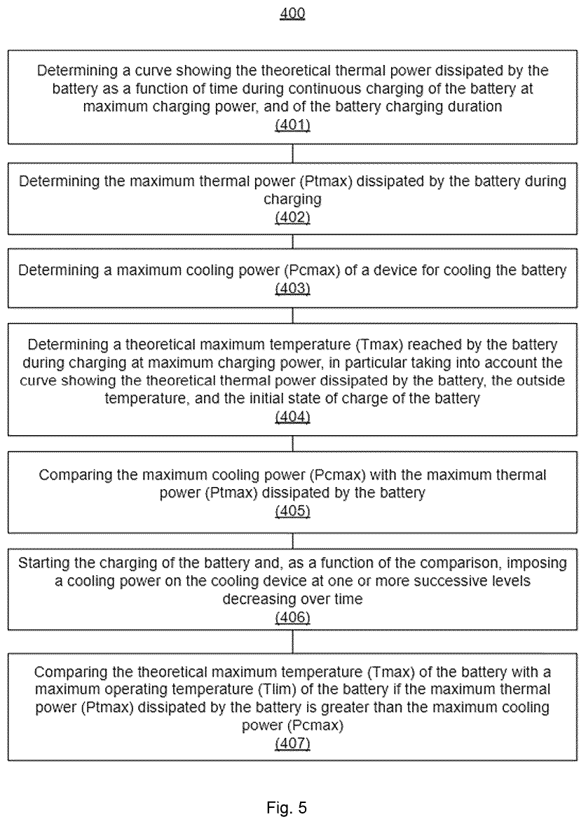

FIG. 5 is a flowchart showing method 400 according to the invention. The method comprises: determining a curve showing the theoretical thermal power 102, 202, 302 dissipated by the battery 4 as a function of time during continuous charging of the battery at maximum charging power, and of the battery charging duration; determining a maximum thermal power Ptmax dissipated by the battery 4 during charging; determining a maximum cooling power Pcmax of a device 6 for cooling the battery 4, determining a theoretical maximum temperature Tmax reached by the battery 4 during charging at maximum charging power, in particular taking into account the curve showing the theoretical thermal power 102, 202, 302 dissipated by the battery 4, the outside temperature, and the initial state of charge of the battery 4; comparing the maximum cooling power Pcmax with the maximum thermal power Ptmax dissipated by the battery 4, and then starting the charging of the battery 4 and, as a function of comparison, imposing a cooling power on the cooling device 6 at one or more successive levels decreasing over time.

In greater detail, firstly the charging of the battery 4 is simulated using a predetermined charging station, for example a charging terminal to which the vehicle is connected, with a maximum power for cooling the battery 4 by means of the cooling device 6. This simulation takes place at maximum charging power, that is, without limiting the amperage of the charging station and for a full charge of the battery 4. This simulation makes it possible to determine a theoretical thermal power curve 102 showing the thermal power dissipated by the battery 4 as a function of time during charging. This theoretical thermal power curve 102 showing the thermal power dissipated by the battery 4 thus makes it possible to determine a maximum thermal power Ptmax dissipated by the battery 4.

This simulation also makes it possible to determine a curve 104 showing the change in the theoretical temperature of the battery 4 as a function of time during charging. This theoretical temperature curve 104 of the battery 4 also makes it possible to determine a maximum temperature Tmax reached by the battery 4 during charging. Preferably, this simulation takes into account the internal resistance of the battery 4, which can vary, in particular as a function of the aging of the cells forming the battery.

This simulation further makes it possible to determine the minimum charging duration.

This simulation particularly takes into account the outside temperature, for example measured using a thermometer provided on the vehicle, together with the initial state of charge of the battery, that is, the state of charge of the battery at the start t0 of the simulation.

In parallel, a maximum cooling power Pcmax of the device 6 for cooling the battery 4 is determined, shown by the straight line 106. This is a predetermined power that depends in particular on the sizing and architecture of the cooling device 6 and on the maximum rotation speed of its compressor. Other parameters such as the thermal power of the heat exchangers and the ambient temperature are also taken into account to determine the maximum cooling power Pcmax. It is therefore a known value, for example given by the supplier of the cooling device 6. The cooling power can be reduced at any time by commanding a reduction in the speed of the compressor and/or the speed of the fan generating an air stream passing through the condenser, so as to obtain a cooling power of between 0 and the maximum cooling power Pcmax of the cooling device 6.

Provision can be made for the device for cooling the battery to be included in an air conditioning device for a vehicle passenger compartment. In this case, the determining of the maximum cooling power Pcmax of the device 6 for cooling the battery 4 corresponds to the maximum cooling power of the air conditioning device minus the cooling power used for cooling the passenger compartment. The cooling method as described hereinafter is then implemented in a similar manner, taking into account the part of the cooling power dedicated to the battery 4.

At the start of charging, the values of the theoretical maximum temperature Tmax of the battery 4 and a maximum operating temperature Tlim of the battery 4 are compared. This maximum operating temperature Tlim of the battery 4 is a predetermined value that depends on the nature, in particular the chemistry, of the battery 4, and is known, for example given by the supplier of the battery 4. This maximum operating temperature Tlim corresponds to a temperature above which the performance of the battery 4 is reduced, and also above which the battery 4 can start to deteriorate.

The embodiment in FIG. 2 corresponds to the situation in which the theoretical maximum temperature Tmax of the battery 4 is above the maximum operating temperature Tlim of the battery 4. This means that despite the maximum cooling power Pcmax of the cooling device 6, unrestricted charging will cause a temperature increase of the battery that is too great to remain below the maximum operating temperature Tlim of the battery 4.

FIG. 2 shows a curve showing the actual thermal power 112 dissipated by the battery 4, the curve showing the actual temperature 114 of the battery 4 and the curve showing the cooling power 116 supplied by the cooling device 6 as a function of time during charging in order to illustrate the effects of the method according to the invention.

The method according to the embodiment in FIG. 2 then firstly comprises a high cooling phase A, during which the charging power is at maximum charging power and during which a maximum cooling power Pcmax is imposed on the cooling device 6, for example at a maximum compressor rotation speed level, throughout the high cooling phase A. In this high cooling phase A, the cooling power 116 supplied by the cooling device 6 is kept at the maximum cooling power Pcmax of the cooling device 6. During this first phase A, the actual thermal power 112 dissipated by the battery 4 over time is equal to the theoretical thermal power 102 dissipated by the battery 4 over time. This is because the battery 4 is being charged at its maximum power. During this high cooling phase A, the cooling power 116 of the cooling device 6 is less than the thermal power 112 dissipated by the battery 4, so that the battery increases in temperature, as shown by the change in the actual temperature 114 of the battery 4, which is equal to the change in the theoretical temperature 104 of the battery 4. The high cooling phase A ends when the actual temperature 114 of the battery 4 reaches its maximum operating temperature Tlim.

Preferably, this high cooling phase A starts when the actual temperature 114 of the battery 4 is greater than or equal to an optimum operating temperature threshold Tmin of the battery 4. This optimum operating temperature threshold Tmin is a temperature below which the battery 4 cannot deliver or receive electric power for its normal operation or charging. This optimum operating temperature threshold Tmin is known data given in particular by the supplier of the battery 4. In other words, in this case the charging of the battery 4 is started without cooling it. This makes it possible to use the charging in order to heat the battery so that its initial temperature T0 exceeds the optimum operating temperature threshold Tmin.

The method according to the embodiment in FIG. 2 comprises, following the high cooling phase A, a charging regulation phase B during which a maximum cooling power is still imposed on the cooling device 6, for example at a maximum compressor rotation speed level. The cooling power 116 supplied by the cooling device 6 is thus still equal to the maximum cooling power Pcmax of the cooling device 6 during this charging regulation phase B. However, a charging power of the battery 4 is now imposed according to a setpoint below the maximum charging power so that the actual thermal power 112 dissipated by the battery 4 is equal to the maximum cooling power Pcmax imposed on the cooling device 6. This reduction in the charging power can in particular be carried out by reducing the charging amperage. The actual thermal power 112 dissipated by the battery 4 is then no longer equal to the theoretical thermal power 102 dissipated by the battery 4, but equal to the maximum cooling power Pcmax of the cooling device 6. This makes it possible to stabilize the actual temperature 114 of the battery 4 in order to prevent it from exceeding its maximum operating temperature Tlim, which would occur if the charging power was not restricted. The actual temperature 114 of the battery 4 is then kept at the maximum operating temperature Tlim of the battery 4. The charging regulation phase B ends when the actual thermal power 112 dissipated by the battery 4, therefore subject to the setpoint, returns to the theoretical thermal power 102 dissipated by the battery 4.

The method according to the embodiment in FIG. 2 comprises, following the charging regulation phase B, a low cooling phase C during which the charging power is at maximum charging power and during which a cooling power 116 is imposed on the cooling device 6 at one or more levels below the maximum cooling power Pcmax of the cooling device 6, until the end of charging of the battery 4. These levels are achieved for example at different intermediate rotation speed levels of the compressor below the maximum rotation speed. During the low cooling phase C, the mean cooling power is thus equal to the mean thermal power dissipated by the battery 4. Here, mean cooling power denotes the mean of the different cooling powers imposed at the different levels of cooling power 116. The low cooling phase ends at the end of charging of the battery 4. The example in FIG. 2 shows the presence of a single level P1 of cooling power 116, but several levels can be envisaged. This is reflected in the fact that the cooling power 116 supplied by the cooling device 6 forms a level at a cooling power P1. The low cooling phase C makes it possible to avoid cooling the battery 4 excessively, which would result in unnecessary energy expenditure. The actual temperature 114 of the battery 4 is then kept close to its maximum operating temperature Tlim. Further, decreasing levels of cooling power 116 due to decreasing levels of rotation speed of the compressor are noticeable to the user and make it possible to indicate to them that the charging of the battery 4 is coming to an end.

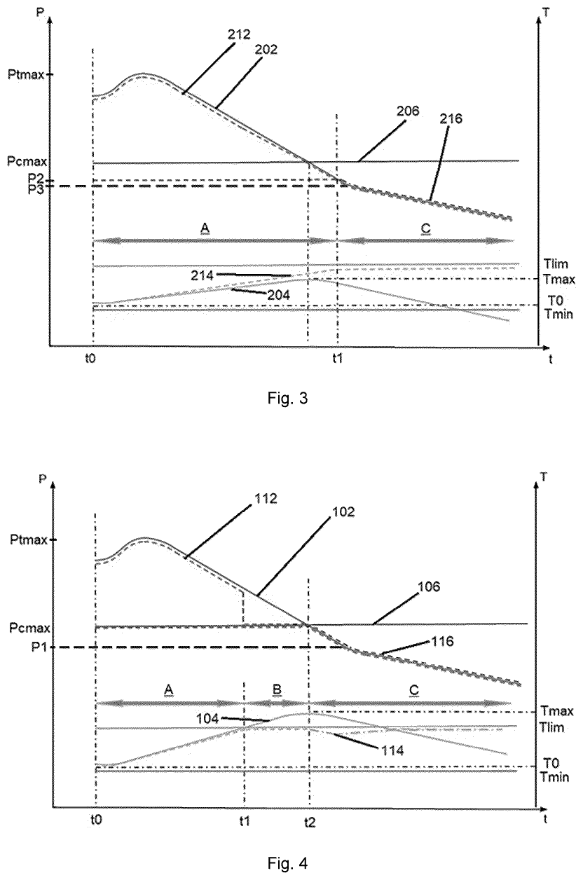

FIG. 3 shows a graph showing the change in the thermal power P dissipated by the battery, the cooling power P supplied by the cooling device, and the temperature T of the battery as a function of time t according to a second embodiment of the cooling method. Elements corresponding to those shown in the preceding figure have reference signs increased by 100 compared to FIG. 2.

The embodiment in FIG. 3 corresponds to a situation in which the theoretical maximum temperature Tmax of the battery 4 is below its maximum operating temperature Tlim. This means that maximum cooling of the battery 4 is sufficient to keep the temperature of the battery 4 at an optimum operating temperature, even without restricting charging. In other words, the maximum cooling power Pcmax, shown by the straight line 206, is greater than the mean thermal power dissipated by the battery 4 during charging. The second charging regulation phase B described with respect to the embodiment in FIG. 2 can thus be dispensed with. Only the high cooling phase A and the low cooling phase C can then be required.

FIG. 3 shows the curve showing the actual thermal power 212 dissipated by the battery 4, the curve showing the actual temperature 214 of the battery 4 and the curve showing the cooling power 216 supplied by the cooling device 6.

The method according to the embodiment in FIG. 3 firstly comprises a high cooling phase A, during which the charging power is at maximum charging power and during which a cooling power at a level P2 below the maximum cooling power Pcmax is imposed on the cooling device 6 throughout the high cooling phase A. This level P2 of cooling power 216 is for example obtained at an intermediate rotation speed level of the compressor below the maximum rotation speed of the compressor. During this high cooling phase A, the cooling power 216 is below the actual thermal power 212 dissipated by the battery 4, so that the actual temperature 214 of the battery increases. The high cooling phase A ends in particular when the actual thermal power 212 dissipated by the battery 4 reaches the level P2 of the cooling power 216 of the cooling device 6.

Preferably, this high cooling phase A starts when the actual temperature 214 of the battery 4 is greater than or equal to an optimum operating temperature threshold Tmin of the battery 4. This optimum operating temperature threshold Tmin is a temperature below which the battery 4 cannot deliver or receive electric power for its normal operation or charging. This optimum operating temperature threshold Tmin is known data given in particular by the supplier of the battery 4. In other words, in this case the charging of the battery 4 is started without cooling it. This makes it possible to use the charging in order to heat the battery so that its initial temperature T0 exceeds the optimum operating temperature threshold Tmin.

The method according to the embodiment in FIG. 3 comprises, following the high cooling phase A, a low cooling phase C during which the charging power is equal to the maximum charging power and during which a cooling power 216 is imposed at one or more levels P3 that decrease over time and are below the level P2 of the high cooling phase A. These levels P3 are obtained for example by the low rotation speed levels of the compressor that decrease over time and are below the intermediate rotation speed level. These levels P3 of cooling power 216 are applied so that, during the low cooling phase, the mean cooling power is equal to the mean thermal power dissipated by the battery 4. The low cooling phase C more particularly ends at the end of charging of the battery. The low cooling phase C makes it possible to avoid cooling the battery 4 excessively, which would result in unnecessary energy expenditure, and to keep the actual temperature 214 of the battery close to, but below, the maximum operating temperature Tlim. Further, decreasing levels of cooling power 216 due to decreasing levels of rotation speed of the compressor are noticeable to the user and make it possible to indicate to them that the charging of the battery 4 is coming to an end.

FIG. 4 shows a graph showing the change in the thermal power P dissipated by the battery, the cooling power P supplied by the cooling device, and the temperature T of the battery as a function of time t according to a third embodiment of the cooling method. Elements corresponding to those shown in the preceding figure have reference signs increased by 100 compared to FIG. 3.

The embodiment in FIG. 4 corresponds to the situation in which the maximum cooling power Pcmax, shown by the straight line 306, is greater than the maximum thermal power Ptmax dissipated during charging at maximum charging power. This means that at any time, the cooling device 6 is capable of supplying a cooling power 316 to the battery 4 that is greater than the actual thermal power 312 dissipated by the battery 4 due to its charging, even without restricting charging. The charging regulation phase B and the low cooling phase C can thus be dispensed with.

The method comprises a single high cooling phase A, ending at the same time as the charging of the battery, during which the charging power is at maximum charging power and during which a cooling power 316 is imposed on the cooling device 6 at one or more levels P4 below the maximum cooling power Pcmax of the cooling device 6, throughout the charging of the battery 4. As previously, these levels P4 are obtained for example by the low rotation speed levels of the compressor that decrease over time and are below the intermediate rotation speed level.

These levels P4 of cooling power 316 are applied so that the actual temperature 314 of the battery 4 remains between the maximum operating temperature Tlim of the battery 4 and the optimum operating temperature threshold Tmin of the battery 4.Preferably, this high cooling phase A starts when the actual temperature 314 of the battery 4 is greater than or equal to an optimum operating temperature threshold Tmin of the battery 4. This optimum operating temperature threshold Tmin is a temperature below which the battery 4 cannot deliver or receive electric power for its normal operation or charging. This optimum operating temperature threshold Tmin is known data given in particular by the supplier of the battery 4. In other words, in this case the charging of the battery 4 is started without cooling it. This makes it possible to use the charging in order to heat the battery so that its initial temperature T0 exceeds the optimum operating temperature threshold Tmin.

The example in FIG. 4 shows the presence of a single level P4 of cooling power 316 of the cooling device 6, selected so that the actual temperature 314 of the battery 4 at the end of charging is close to its maximum operating temperature Tlim, which makes it possible to avoid cooling the battery 4 excessively, which would result in unnecessary energy expenditure. It is however possible to envisage one or more levels P4 of cooling power 316 selected so that the battery 4 has an actual temperature 314 substantially equal to the maximum operating temperature Tlim at the end of charging.

The invention is not limited to the embodiments presented, and further embodiments will be clearly apparent to a person skilled in the art.

What is claimed is:

1. A method for cooling a of an electric or hybrid vehicle, comprising:
determining a curve showing the theoretical thermal power dissipated by the battery as a function of time during continuous charging of the battery at maximum charging power, and of the battery charging duration,
determining maximum thermal power dissipated by the battery during charging,
determining a maximum cooling power of a device for cooling the battery,
determining a theoretical maximum temperature reached by the battery during charging at maximum charging power,
comparing the maximum cooling power with the maximum thermal power dissipated by the battery, and then
starting the charging of the battery and, as a function of comparison, imposing a cooling power on the cooling device at one or more successive levels decreasing over time.

2. The method as claimed in claim 1, wherein if the maximum thermal power dissipated by the battery is greater than the maximum cooling power, the method further comprises comparing the theoretical maximum temperature of the battery with a maximum operating temperature of the battery.

3. The method as claimed in claim 2, wherein if the theoretical maximum temperature of the battery is above the maximum operating temperature of the battery, the method further successively comprises:
a first high cooling phase, during which the charging power is at maximum charging power and during which a first level is imposed on the cooling power that is equal to the maximum cooling power of the cooling device, throughout the high cooling phase,
a charging regulation phase, following the high cooling phase, during which the first level is still imposed on the cooling power that is equal to the maximum cooling power of the cooling device, together with a charging power of the battery according to a setpoint below the maximum charging power so that the thermal power dissipated by the battery is equal to the maximum cooling power imposed on the cooling device, and
a low cooling phase, following the charging regulation phase, during which the charging power is at maximum charging power and during which a cooling power is imposed on the cooling device at one or more primary levels, until the end of charging of the battery so that, during the low cooling phase, the mean cooling power is equal to the mean thermal power dissipated by the battery, the low cooling phase ending at the end of charging of the battery.

4. The method as claimed in claim 3, wherein the high cooling phase ends when the actual temperature of the battery reaches the maximum operating temperature.

5. The method as claimed in claim 3, wherein the charging regulation phase ends when the actual thermal power dissipated by the battery returns to the theoretical thermal power dissipated by the battery.

6. The method as claimed in claim 2, wherein if the theoretical maximum temperature of the battery is below the maximum operating temperature of the battery, the method further successively comprises:
a high cooling phase, during which the charging power is at maximum charging power and during which a cooling power is imposed on the cooling device at a secondary level below the maximum cooling power of the cooling device, throughout the high cooling phase,
a low cooling phase, following the high cooling phase, during which the charging power is at maximum charging power and during which a cooling power is imposed at one or more tertiary levels that decrease over time and are below the secondary level of the high cooling phase, so that, during the low cooling phase, the mean cooling power is equal to the mean thermal power dissipated by the battery, the low cooling phase ending at the end of charging of the battery.

7. The method as claimed in claim 6, wherein the high cooling phase ends when the thermal power dissipated by the battery reaches the secondary level of the cooling power of the cooling device.

8. The method as claimed in claim 1, wherein if the maximum cooling power is greater than the maximum thermal power dissipated by the battery during charging at maximum charging power, the method further comprises a single high charging phase, ending at the same time as the charging of the battery, during which the charging power is at maximum charging power and during which a cooling power is imposed on the cooling device at one or more quaternary levels below the maximum cooling power of the cooling device, throughout the charging of the battery, so that the actual temperature of the battery remains between the maximum operating temperature of the battery and an optimum operating temperature threshold of the battery.

9. The method as claimed in claim 3, wherein the high cooling phase starts if the initial temperature of the battery is greater than or equal to the optimum operating temperature threshold of the battery.

10. The method as claimed in claim 1, wherein the device for cooling the battery is included in an air conditioning device for a vehicle passenger compartment, with the determining of the maximum cooling power of the device for cooling the battery corresponding to the maximum cooling power of the air conditioning device minus the cooling power used for cooling the passenger compartment.

11. The method as claimed in claim 1, wherein determining a theoretical maximum temperature reached by the battery during charging at maximum charging power takes into account the curve showing the theoretical thermal power dissipated by the battery, the outside temperature, and the initial state of charge of the battery.
